(19) United States
(12) Patent Application Publication
(10) Pub. No.: US 2017/0005708 A1
(43) Pub. Date: Jan. 5, 2017

(54) STA ASSISTED DYNAMIC SOUNDING IN MULTIUSER BEAMFORMING

(71) Applicant: QUALCOMM Incorporated, San Diego, CA (US)

(72) Inventors: Aimer Bhat, Bangalore (IN); Venu Pakalapaty, Bangalore (IN)

(21) Appl. No.: 14/790,826

(22) Filed: Jul. 2, 2015

(51) Int. Cl. H04B 7/04; H04L 1/16; H04B 7/06

(52) U.S. Cl. CPC H04B 7/0452; H04B 7/0632; H04B 7/0617; H04L 1/1621

(57) ABSTRACT

Systems and methods are disclosed for dynamically determining whether to sound a channel to determine new beamforming weights for use in MU-MIMO communication systems. A wireless station may receive a beamformed data communication from a wireless device such as a beamformer. The station may determine an indication of channel throughput from the beamformed data communication, and compare the indication of channel throughput to a threshold. If the indication of channel throughput is below the threshold, this may indicate that the beamforming weights are stale, and the wireless device may transmit a notification of stale beamforming weights to the beamformer. The beamformer may then determine whether to sound the channel to determine new beamforming weights.

### TECHNICAL FIELD

The example embodiments generally relate to wireless communication systems and more specifically to systems and methods for ensuring sufficient throughput when communicating using multiuser MIMO protocols.

### BACKGROUND

A current area of development in wireless communications systems involves the use of transmitters and receivers having multiple antennas. Generally, these are known as multiple-input multiple-output (MIMO) systems and offer increased peak data rate, spectral efficiency, and quality of service though the use of a plurality of parallel data streams.

Relative to other wireless technologies, MIMO may enable substantial gains in both system capacity and transmission reliability without requiring an increase in frequency spectrum resources. By increasing the number of transmit and receive antennas, the capacity of a MIMO channel may be increased while also reducing the probability of all sub-channels between the transmitter and receiver fading simultaneously. However, recovery of transmitted information in a MIMO system may be more complex than non-MIMO systems and correspondingly benefit from accurate characterization of the channel. Accordingly, any of a variety of channel models may be used to tailor aspects of the operation of the transceiver to help optimize performance. Further, the characteristics of the channel may vary over time, which may warrant selecting different models to more accurately characterize the channel. In particular, operation in multi user (MU) MIMO modes may be relatively sensitive to the channel statistics. It would therefore be desirable to determine channel statistics in order to allow improved operation of the system.

Another aspect of the operation of MIMO systems is the capability to operate in a variety of modes. MIMO systems can be divided into operational classes including single-user MIMO (SU-MIMO) classes and MU-MIMO classes. Further, MU-MIMO modes may be subdivided depending upon the number of users receiving the MIMO communications. For example, the term “MU2” may refer to a MU-MIMO mode involving a simultaneous transmission to two users, and more generally, the term “MUn” may involve a simultaneous transmission to a number n of users. An objective of SU-MIMO communications may be to increase peak data rate per terminal or station, whereas an objective of MU-MIMO communications may be to increase sector (or service cell) capacity. Operation in each of these classes has corresponding advantages. For example, SU-MIMO communications exploit spatial multiplexing to provide increased throughput and reliability, while MU-MIMO communications exploit multi-user multiplexing (or multi-user diversity) to increase capacity. Additionally, MU-MIMO communications benefit from spatial multiplexing even when employing a receiver having a single antenna. As such, it would be desirable for the MIMO system to select from a number of available operating modes in order to improve overall performance of the system.

Due to the complexity associated with providing multiple transmit streams having adjusted phase and amplitude, MIMO systems rely on having accurate and current channel state information (CSI). In a closed-loop beamforming system, the channel may be estimated using a sounding operation. By sending a known pattern of information, characteristics of the signal appearing at the receiver—also called a beamformee (BFEE)—may be used to determine the CSI, which is then fed back to the transmitter. The transmitter—also called a beamformer (BFER)—may then calculate a matrix of appropriate beamforming weights for communications over the channel. However, the transmission of the sounding signal represents overhead that may limit the overall throughput of the system. Since the benefit of providing current CSI by performing more frequent sounding protocols is offset by the increase in overhead, it would be desirable for a sounding protocol to efficiently determine when to sound the channel.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

An apparatus and methods for communication in a multiple input multiple output (MIMO) system are disclosed. For at least some example embodiments, a first wireless device receives a beamformed data transmission from a second wireless device, determines an indication of channel throughput from the beamformed data transmission, compares the indication of channel throughput to a threshold, and, based at least in part on a determination that the indication of channel throughput is below the threshold, transmits a notification of stale beamforming weights to the second wireless device. The indication of channel throughput (or an indication of goodput) may be based at least in part on an estimation of a signal to interference plus noise ratio (SINR). For example embodiments, the beamformed data transmission may be received using a minimum mean squared error (MMSE) detector, and the MMSE detector may estimate the SINR. According to some other embodiments, the notification of stale beamforming weights may indicate that the wireless device should update at least one beamforming attribute. For some implementations, updating the at least one beamforming attribute may include calculating new beamforming weights using a channel sounding procedure. For other implementations, the notification of stale beamforming weights may include one or more reserved bits in a block acknowledgment frame transmitted to the wireless device. According to further other embodiments, comparing the indication of channel throughput to a threshold may comprise comparing the indication of channel throughput to a plurality of thresholds, wherein each of the plurality of thresholds corresponds to a different MIMO mode.

Another suitable method includes transmitting, from the second wireless device, a beamformed data transmission to the first wireless device, receiving a notification of stale beamforming weights from the first wireless device, determining that at least one beamforming attribute for communications with the first wireless device should be updated, and updating at least one beamforming attribute for communications with the first wireless device. For some implementations, updating at least one beamforming attribute may include performing a channel sounding procedure to determine new beamforming weights for communications with the wireless device. For other implementations, updating at least one beamforming attribute may include switching to a different beamforming mode, such as a single user beamforming (SU-BF) mode. According to further other embodiments, determining that at least one beamforming attribute for communications with the wireless device should be updated may be based at least in part on at least a packet error rate (PER) or a bit error rate (BER). According to some other embodiments, the notification of stale beamforming weights may include one or more reserved bits in a block acknowledgment frame received from the first wireless device.

### BRIEF DESCRIPTION OF THE DRAWINGS

The example embodiments are illustrated by way of example and are not intended to be limited by the figures of the accompanying drawings, where:

FIG. 1 shows a block diagram of a wireless MIMO system, within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 depicts an example channel sounding operation and an example MU-MIMO data communication, in accordance with example embodiments.

FIG. 5 depicts an example graph of data throughput versus channel sounding gap duration, for several example MU-MIMO modes.

FIG. 6 depicts an example graph of average signal to interference plus noise ratio (SINR) versus channel sounding gap duration, for several example MU-MIMO modes.

FIG. 7 shows an illustrative flowchart depicting operations for dynamically notifying a BFER that it may be using stale beamforming weights, in accordance with example embodiments.

FIG. 8 shows an illustrative flowchart depicting operations for dynamically determining whether to update beamforming characteristics, in accordance with example embodiments.

Like reference numbers refer to corresponding parts throughout the drawing figures.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots.

In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), media access control (MAC) layer protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits.

Further, the term “goodput” may refer to an effective data rate of a wireless channel or link between two wireless devices (e.g., between a STA and an AP), where the header and other non-load information might not affect calculating the effective data rate, whereas “throughput” may refer to the raw data rate (e.g., average number of total bits over time). For example embodiments, the goodput value of an AP may be indicative of the available bandwidth or medium share of a wireless channel upon which the AP operates. The term “sounding packet” may refer to a frame or packet that includes a predetermined pattern of information (e.g., a training sequence) that is known to a receiving device and that may be used as a basis for estimating channel conditions and/or goodput values of APs. For example, a null data packet (NDP), which does not contain data, may be used as a sounding packet. Thus, the term “NDP” may be used interchangeably with the term “sounding packet.”

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As described above, when wireless devices communicate in a MU-MIMO system using beamforming—e.g., according to the IEEE 802.11n or IEEE 802.11ac standards—it is important that the matrix of beamforming weights adequately reflects current channel conditions. In particular, when the matrix of beamforming weights no longer reflects current channel conditions, throughput may significantly decrease. This decrease in throughput may be greater as the number of users in the MU-MIMO mode increases. However, determining the matrix of beamforming weights requires the exchange of sounding packets between the wireless devices, and represents overhead that may limit the overall throughput of the system. Accordingly, it would be desirable to ensure beamforming weights sufficiently reflect current channel conditions to ensure adequate throughput while also limiting the overhead associated with channel sounding.

In accordance with some embodiments, a wireless device may determine an indication of channel throughput or goodput based at least in part on received data signals. While the following examples are discussed in terms of throughput, it should be noted that either goodput or throughput may be used in different embodiments. If the indication of channel throughput is below a threshold, this may indicate that the beamforming weights are stale, and the wireless device may notify the transmitter of the channel state information. The transmitter may then update at least one beamforming attribute (e.g., by sounding the channel to determine new beamforming weights, changing the beamforming mode, etc.).

In accordance with some embodiments, the wireless device may use a minimum mean squared error (MMSE) detector for receiving MU-MIMO signals. MU-MIMO transmissions do not null out interference on all receive chains, but only null interference between spatial streams. Use of an MMSE detector may improve performance by suppressing residual interference. An additional benefit is that the MMSE detector may estimate a signal to interference plus noise ratio (SINR), for example, using MMSE techniques applied to the received beamformed data. SINR is related to system throughput, and may be indicative of channel conditions. In accordance with some embodiments, the indication of channel throughput (or for other embodiments, an indication of goodput) may be based at least in part on an SINR value.

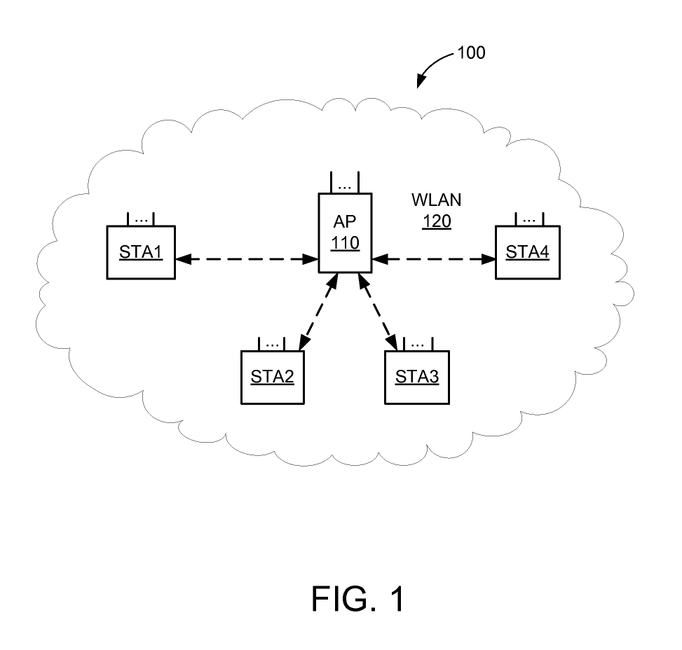

To help illustrate the systems and methods of this disclosure, an example wireless MIMO system 100 is shown in FIG. 1, including access point (AP) 110, four wireless stations STA1-STA4, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. As shown, AP 110 communicates with one or more wireless stations (STAs), such as STA1, STA2, STA3, and/or STA4. For simplicity, one AP and four stations STA1-STA4 are shown, but the example embodiments may be applied to any other suitable number of network nodes. AP 110 may communicate with one or more stations STA1-STA4 at any given moment on the downlink path and/or on the uplink path. The downlink path (e.g., the forward link) is the communication link from AP 110 to STA1-STA4, and the uplink path (e.g., the reverse link) is the communication link from STA1-STA4 to AP 110.

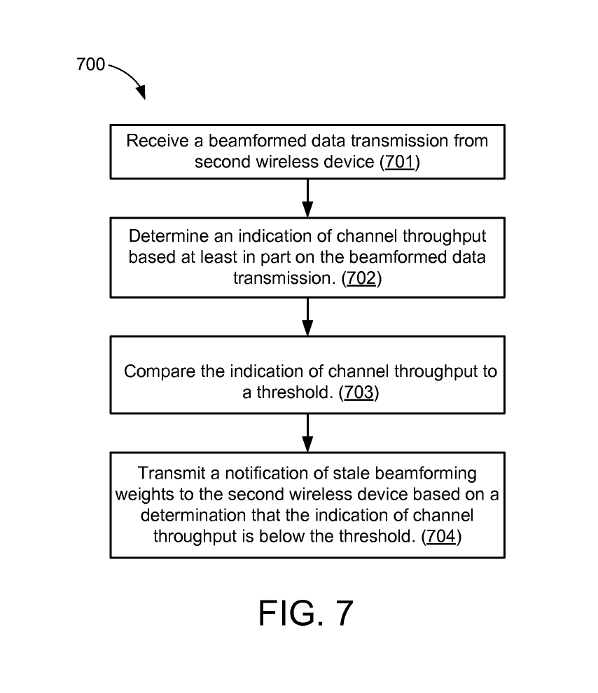

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

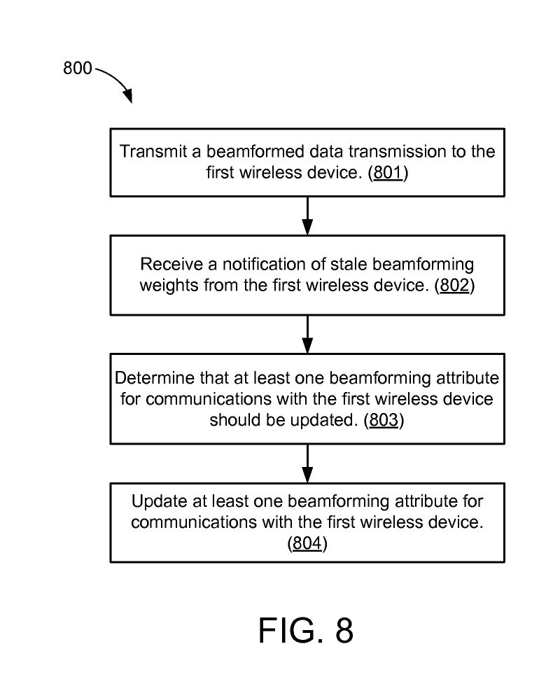

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 8.

MIMO system 100 may employ multiple transmit antennas and multiple receive antennas for data transmission on the downlink and uplink paths. For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

AP 110 may include a number n of antennas to provide multiple-input (MI) for downlink transmissions and multiple-output (MO) for uplink transmissions. A selected subset of stations associated with AP 110 may provide the MO for downlink transmissions and may provide the MI for uplink transmissions. In some embodiments, the selected subset of stations may include up to n stations, although multiplexing techniques may be employed to increase the number of stations in the selected subset. The stations in the selected subset may have the same number or a different number of antennas.

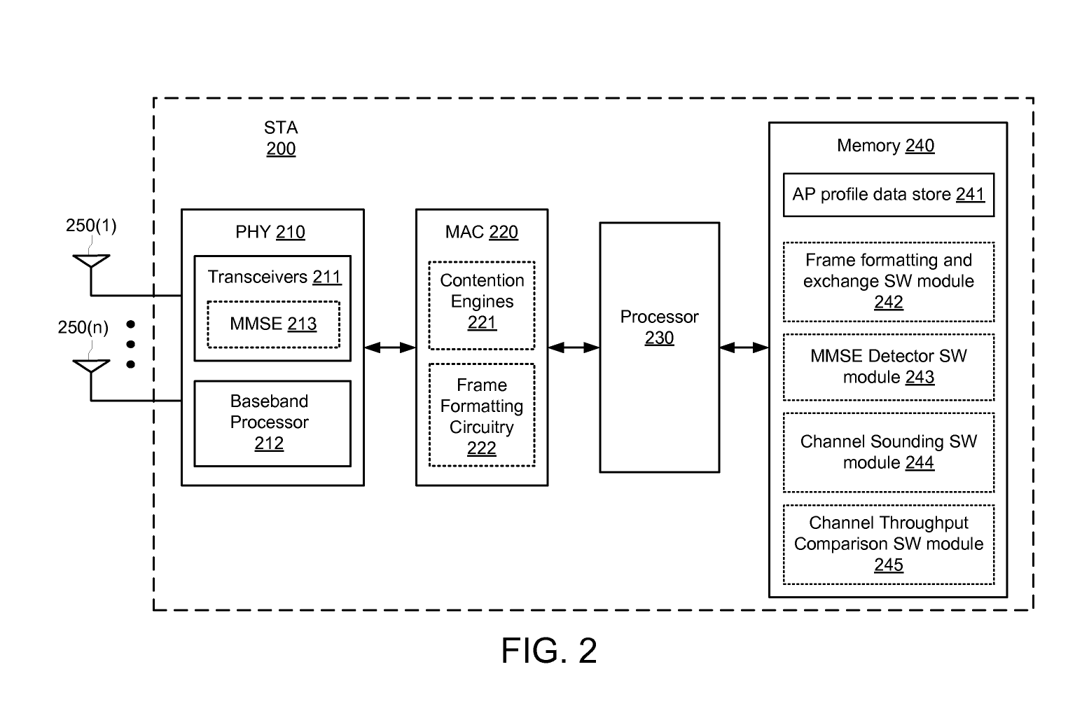

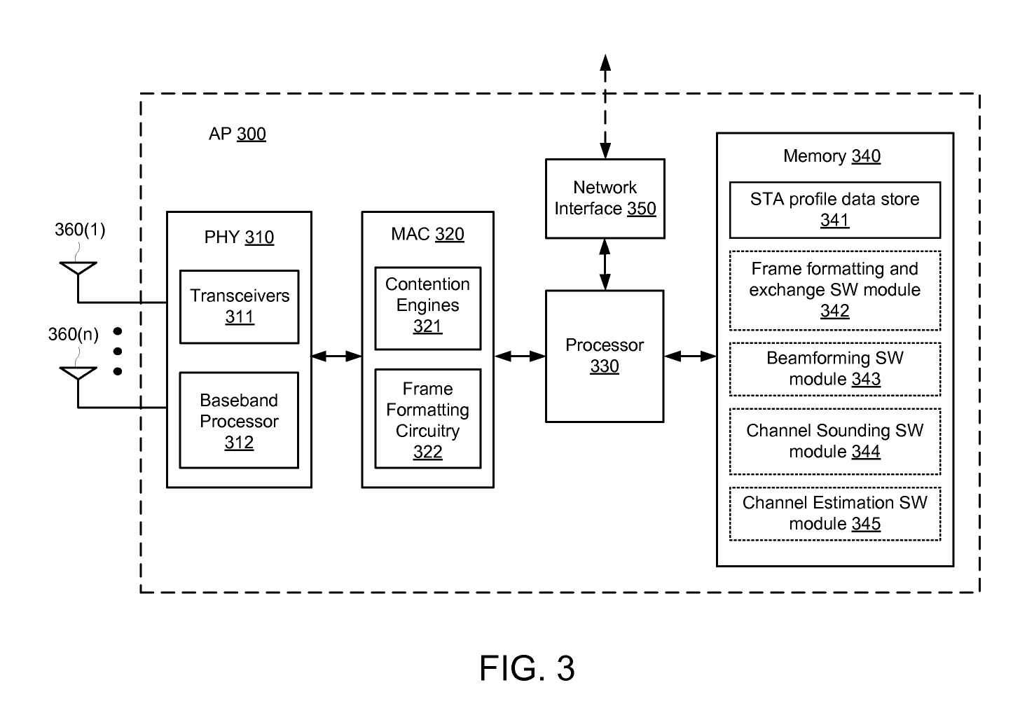

Additional details regarding embodiments of STA1-STA4 and AP 110 are depicted as high level schematic blocks in FIG. 2 and FIG. 3, respectively. AP 110 may be a transmitting entity for the downlink path and a receiving entity for the uplink path, while each of stations STA1-STA4 may be a transmitting entity for the uplink path and a receiving entity for the downlink path. As used herein, a “transmitting entity” is an independently operated apparatus or device capable of transmitting data via a wireless channel, and a “receiving entity” is an independently operated apparatus or device capable of receiving data via a wireless channel. Beam-steering, beamforming, and/or another suitable spatial processing technique may be used by AP 110 and stations STA1-STA4.

FIG. 2 shows an example STA 200 that may be one embodiment of any of the stations STA1-STA4 of FIG. 1. The STA 200 may include a physical layer (PHY) device 210 including at least a number of transceivers 211 and a baseband processor 212, may include a MAC 220 including at least a number of contention engines 221 and frame formatting circuitry 222, may include at least one processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for multiple-input, multiple-output (MIMO) operations. The MIMO operations may include SU-MIMO and MU-MIMO operations.

The transceivers 211 may include a number of MMSE detectors 213 (for simplicity, only one MMSE detector 213 is shown in FIG. 2). For at least some example embodiments, each of a number of the receive chains within transceiver 211 includes one or more MMSE detectors 213. The MMSE detectors 213, which may be any suitable circuit, device, or module that may be configured to estimate CSI (or other indicators of channel conditions) using MMSE techniques described herein, may estimate the SINR based at least in part on received beamformed data transmissions. As an addition or an alternative, the MMSE detectors 213 may use any suitable MMSE technique to facilitate channel estimation. For other embodiments, the MMSE detectors 213 may be located external to the PHY device 210.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

The contention engines 221 may contend for access to one more shared wireless mediums, and may also store packets for transmission over the one more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220 of device 200) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include an AP profile data store 241 that stores profile information for a plurality of APs. The profile information for a particular AP may include information including, for example, the AP's SSID, MAC address, channel information, RSSI values, goodput values, channel state information (CSI), supported data rates, connection history with STA 200, a trustworthiness value of the AP (e.g., indicating a level of confidence about the AP's location, etc.), and any other suitable information pertaining to or describing the operation of the AP.

Memory 240 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 242 to facilitate the creation and exchange of any suitable frames (e.g., data frames, action frames, and management frames) between STA 200 and other wireless devices (e.g., as described below for one or more operations of FIG. 7;
a minimum mean squared error (MMSE) detector software module 243 to facilitate the detection and reception of MU-MIMO signals from other wireless devices (e.g., as described below for one or more operations of FIG. 7);
a channel sounding software module 244 to facilitate the generation and transmission of responses to sounding packets transmitted by other wireless devices (e.g., as described below for one or more operations of FIG. 7); and
a channel throughput comparison software module 245 to facilitate the generation of estimations of channel throughput and the comparison of such estimations to one or more thresholds (e.g., as described below for one or more operations of FIG. 7).

Each software module includes instructions that, when executed by processor 230, cause STA 200 to perform the corresponding functions. The non-transitory computer-readable medium of memory 240 thus includes instructions for performing all or a portion of the STA-side operations depicted in FIG. 7.

Processor 230, which is shown in the example of FIG. 2 as coupled to PHY device 210, to MAC 220, and to memory 240, may be any suitable one or more processors capable of executing scripts or instructions of one or more software programs stored in STA 200 (e.g., within memory 240). For example, processor 230 may execute the frame formatting and exchange software module 242 to facilitate the creation and exchange of any suitable frames (e.g., data frames, action frames, and management frames) between STA 200 and other wireless devices. Processor 230 may also execute the MMSE detector software module 243 to facilitate the detection and reception of MU-MIMO signals from other wireless devices. Processor 230 may also execute the channel sounding software module 244 to facilitate the generation and transmission of responses to sounding packets transmitted by other wireless devices. Processor 230 may also execute the channel throughput comparison software module 245 to facilitate the generation of estimations of channel throughput and the comparison of such estimations to one or more thresholds.

FIG. 3 shows an example AP 300 that may be one embodiment of the AP 110 of FIG. 1. AP 300 may include a PHY device 310 including at least a number of transceivers 311 and a baseband processor 312, may include a MAC 320 including at least a number of contention engines 321 and frame formatting circuitry 322, may include a processor 330, may include a memory 340, may include a network interface 350, and may include a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The network interface 350 may be used to communicate with a WLAN server (not shown for simplicity) either directly or via one or more intervening networks and to transmit signals. For at least some embodiments, the network interface 350 may provide a backhaul connection to one or more wired networks and/or one or more other wireless networks.

Processor 330, which is coupled to PHY device 310, to MAC 320, to memory 340, and to network interface 350, may be any suitable one or more processors capable of executing scripts or instructions of one or more software programs stored in AP 300 (e.g., within memory 340). For purposes of discussion herein, MAC 320 is shown in FIG. 3 as being coupled between PHY device 310 and processor 330. For actual embodiments, PHY device 310, MAC 320, processor 330, memory 340, and/or network interface 350 may be connected together using one or more buses (not shown for simplicity).

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, previous AP-initiated channel sounding requests, supported data rates, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames (e.g., data frames, action frames, and management frames) between AP 300 and other wireless devices (e.g., as described below for one or more operations of FIG. 8;
a beamforming software module 343 to facilitate the generation and application of beamforming attributes—such as beamforming weights and beamforming modes—to communications with other wireless devices (e.g., as described below for one or more operations of FIG. 8);
a channel sounding software module 344 to facilitate the generation and transmission of sounding packets to other wireless devices, and the generation and transmission of responses to sounding packets transmitted by other wireless devices (e.g., as described below for one or more operations of FIG. 8); and
a channel estimation software module 345 to facilitate the estimation of channel conditions and to determine whether changes in channel conditions necessitate updating one or more parameters relating to communications with other wireless devices (e.g., as described below for one or more operations of FIG. 8).

Each software module includes instructions that, when executed by processor 330, cause AP 300 to perform the corresponding functions. The non-transitory computer-readable medium of memory 340 thus includes instructions for performing all or a portion of the AP-side operations depicted in FIG. 8.

Processor 330, which is shown in the example of FIG. 3 as coupled to PHY device 310 via MAC 320, to memory 340, and to network interface 350, may be any suitable one or more processors capable of executing scripts or instructions of one or more software programs stored in AP 300 (e.g., within memory 340). For example, processor 330 may execute the frame formatting and exchange software module 342 to facilitate the creation and exchange of any suitable frames (e.g., data frames, action frames, and management frames) between AP 300 and other wireless devices. Processor 330 may also execute the beamforming software module 343 to facilitate the generation and application of beamforming attributes—such as beamforming weights and beamforming modes—to communications with other wireless devices. Processor 330 may also execute the channel sounding software module 344 to facilitate the generation and transmission of sounding packets to other wireless devices, and the generation and transmission of responses to sounding packets transmitted by other wireless devices. Processor 330 may also execute the channel estimation software module 345 to facilitate the estimation of channel conditions and to determine whether changes in channel conditions necessitate updating one or more parameters relating to communications with other wireless devices.

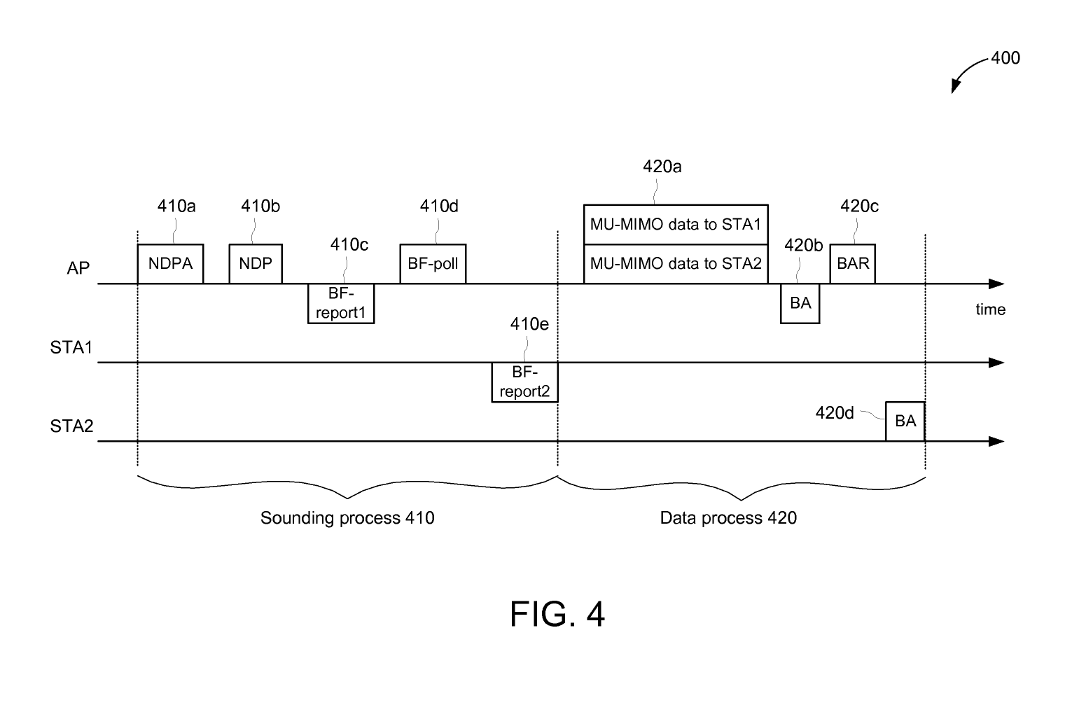

As described above, determining the matrix of beamforming weights requires the exchange of sounding packets between the wireless devices. For example, FIG. 4 shows example MU-MIMO channel sounding operation 400 between an AP and two STAs, according to example embodiments. The channel sounding operation 400 may include a sounding process 410 and a data communication process 420. The sounding process 410 may be used to determine a matrix of appropriate beamforming weights, and the data communication process 420 may be used to deliver downlink data to the STAs.

As shown in FIG. 4, during the sounding process 410, an AP (BFER) may send a null data packet announcement (NDPA) frame 410a to receiving stations (BFEEs) STA1 and STA2. NDPA frame 410a may be used to gain control of the channel, to identify which stations are to respond, and to indicate an order in which the identified stations are to respond. Note that while only two stations are depicted in FIG. 4, other numbers of receiving stations may participate in sounding process 410. Stations which receive the NDPA but which are not targeted may defer contending for channel access until sounding process 410 has completed.

After sending the NDPA 410a, the AP may send a null data packet (NDP) 410b. NDP 410b may contain training fields, such as OFDM training fields, which have known values. The receiving stations, e.g., STA1 and STA2, may use the training fields of NDP 410b to calculate a channel response matrix. After receiving NDP 410b and calculating the channel response matrix, the first responding station—STA1 in FIG. 4—responds with a beamforming report (BF-report1) 410c. BF-report1 410c indicates how the training fields in the NDP were received, and therefore how the AP should steer beamformed frames to STA1.

After receiving BF-report1 410c, the AP may transmit a beamforming report poll (BF-poll) frame 410d to request the next targeted station—STA2 in FIG. 4—to send its channel response matrix. BF-poll 410d may indicate which station should respond, and which segments of its channel response should be transmitted. In accordance with example embodiments, BF-poll frames may also be used to indicate that a station which has already transmitted a BF-report frame should retransmit part or all of its channel response matrix. After receiving BF-poll 410d, the targeted station—STA2 in FIG. 4—responds with its channel response matrix in BF-report2 410e. The AP may subsequently transmit BF-poll frames to remaining targeted stations, each of which may respond with a BF-report frame.

After receiving all channel response matrices from targeted stations, the AP may calculate a matrix of appropriate beamforming weights for the targeted STAs. This matrix of beamforming weights may also be called a steering matrix. The AP may then use the beamforming weights for data communications with the targeted stations. For example, as depicted in data communications process 420 of FIG. 4, the AP may send MU-MIMO data 420a to STA1 and STA2. STA1 may respond with a block acknowledgement (BA) frame 420b. The AP may send a BA request (BAR) frame 420c to STA2, and STA2 may respond with a BA frame 420d.

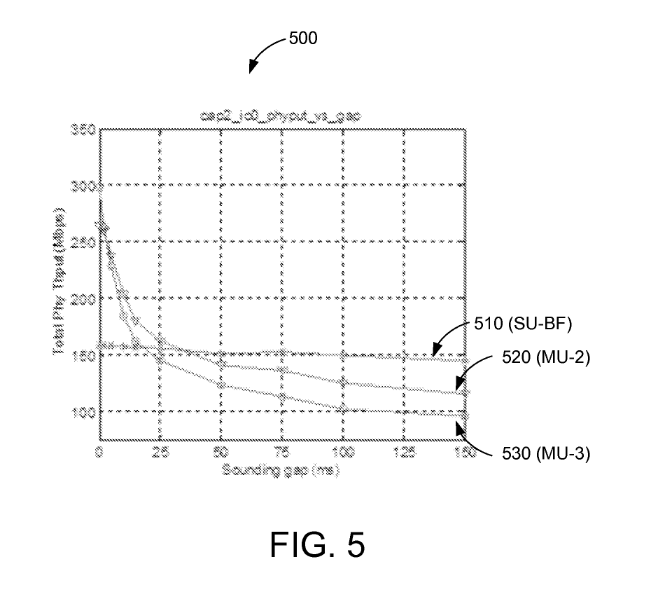

FIG. 5 depicts a graph 500 showing an example relationship between throughput and sounding gap duration (e.g., how much time elapses between successive channel sounding operations). As shown in FIG. 5, throughput may decline as more time elapses between successive channel sounding operations. This decline may indicate that beamforming weights used by the BFER become less and less appropriate for current channel conditions as more time elapses between successive sounding operations. The beamforming weights may be called “stale” when they no longer reflect current channel conditions. The effects of stale beamforming weights may be more significant as the number of users in the MU mode increases. For example, as shown in FIG. 5, the throughput 530 for a MU-3 mode may be more sensitive to increases in the sounding gap than throughput 520 for a MU-2 mode and throughput 510 for an SU-BF mode.

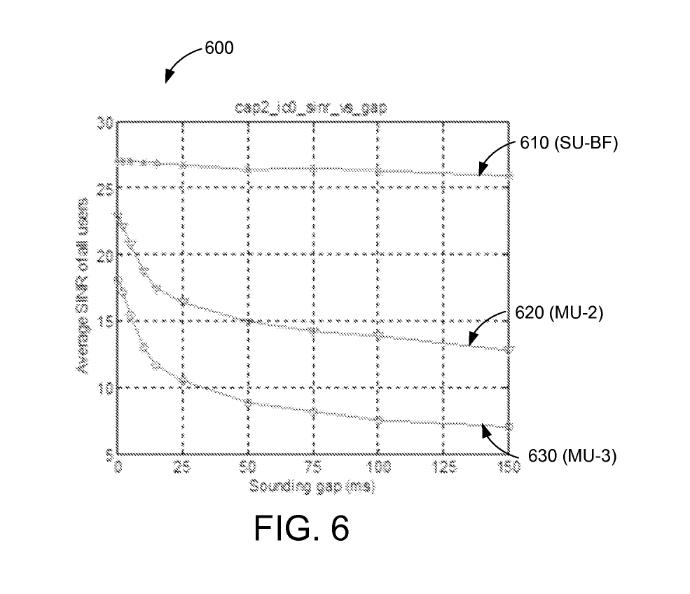

FIG. 6 depicts a graph 600 showing an example relationship between average signal to interference plus noise ratio (SINR) and sounding gap duration. As shown in FIG. 6, SINR may decline as the sounding gap increases. SINR is closely related to system throughput. Accordingly, as shown in FIG. 6, as the sounding gap increases, SINR declines, indicating a decline in system throughput. Further, it is noted that the SINR 610 for the SU-BF mode is greater than the SINR 620 for the MU-2 mode, and the SINR 620 for the MU-2 mode is greater than the SINR 630 for the MU-3 mode.

In accordance with example embodiments, BFEE stations may employ a minimum mean squared error (MMSE) detector for receiving MU-MIMO signals (e.g., the MMSE detector 213 of the STA 200 shown in FIG. 2). As described above, use of an MMSE detector may improve performance by suppressing residual interference not otherwise suppressed by MU-MIMO transmissions. An additional benefit of the MMSE detector may be that a signal to interference plus noise ratio (SINR) may be calculated based at least in part on the MMSE detector equations. For example, consider a MU-MIMO system with one AP and a number of STAs. In accordance with example embodiments, a given STA may have a channel estimate matrix H, of dimension Nrx (indicating a number of receive antennas) by Nss (indicating a number of spatial streams). This channel estimate matrix may include the beamforming weights used by the BFER because the training fields used to calculate the channel estimate matrix—e.g., the training fields in NDP 410b of FIG. 4—are beamformed. If Nrx≦Nss, then the MMSE weights may be expressed as:

W=H^{H}(αI_{Nrx}+HH^{H})⁻¹

where α is a scalar based at least in part on the received signal to noise ratio (SNR), I_{Nrx} is an identity matrix of dimension Nrx by Nrx, and H^{H} is the Hermitian of the channel estimate matrix H.

In accordance with example embodiments, the MMSE estimate of the transmitted signal X may be expressed as:

X_{MMSE}=WY=WHX+Wn

where Y is the signal received by the receiver, and n is the noise vector. Assuming the i^{th} STA has only one stream corresponding to xᵢ, the interference may be expressed as:

Iᵢ=WᵢHᵢ

where Hᵢ is H without the i^{th} column and Wᵢ is the 1 by Nrx vector containing the i^{th} column of W. Note that Iᵢ may have dimension 1 by (Nss−1). The expected noise level may accordingly be a WᵢWᵢ^{H}. Consequently, the SINR at the STA may be expressed as:

SINR=P/(IᵢIᵢ^{H}+αWᵢWᵢ^{H})

where P is the signal power.

As shown above, an SINR value may be determined by a receiver without requiring additional information beyond that required for use by the MMSE detector. Because SINR may be related to system throughput (e.g., as depicted in FIGS. 5 and 6), a station may determine whether system throughput is adversely affected by stale beamforming weights by comparing this SINR to a threshold. A station may compare this SINR to a threshold for each supported MU-MIMO mode (e.g., to a first threshold for a SU-BF mode, to a second threshold for a MU-2 mode, to a third threshold for a MU-3 mode, etc.). Determining that the SINR is below the threshold associated with the corresponding MIMO mode may indicate that the BFER is using stale beamforming weights, and that system throughput may be adversely affected.

In accordance with example embodiments, a BFEE station which determines that SINR is below a threshold may transmit an indication message, to the BFER, indicating that the BFER may be using stale beamforming weights. The indication message may be included in a block acknowledgement (BA) frame transmitted to the BFER—e.g., in BA frame 420b or BA frame 420d of FIG. 4. For some implementations, the indication message may be included in one or more of the reserved bits of the BA frame. For other implementations, the indication message may be a one-bit field for each supported MU-MIMO mode, where each one-bit field indicates whether SINR is below a threshold associated with the MU-MIMO mode (e.g., one bit indicates whether SINR is below the threshold for a SU-BF mode, another one bit indicates whether SINR is below the threshold for a MU-2 mode, etc.).

A BFER which receives a message indicating a low SINR (e.g., an SINR that is below a threshold associated with the corresponding MIMO mode) may determine whether to change at least one of its beamforming characteristics, e.g., by sounding the channel to determine new beamforming weights. In accordance with example embodiments, a BFER may determine whether to sound the channel based at least in part on one or more of: the indication message received from the BFEE, packet error rate (PER) statistics, bit error rate (BER) statistics, and other suitable link quality parameters. If the BFER determines to sound the channel, the BFER may perform channel sounding process 410 of FIG. 4 or another similar channel sounding procedure.

For other embodiments, a BFER which receives a message indicating a low SINR may determine to switch to a different MIMO mode which is less sensitive to changes in the channel (e.g., than the current MIMO mode). For example, the BFER may determine that better throughput may likely be obtained by switching from a MU-MIMO mode to a SU-BF mode. More specifically, as depicted in FIG. 5, the SU-BF mode is far less sensitive to changes in the channel caused by stale beamforming weights than either the MU-2 mode or the MU-3 mode. The BFER may determine to avoid the overhead associated with channel sounding operations, and instead switch to another MIMO mode that is less sensitive to changes in channel conditions.

FIG. 7 is an illustrative flow chart depicting an example operation 700 for a first wireless device (the BFEE) dynamically notifying a second wireless device (the BFER) that it may be using stale beamforming weights, in accordance with example embodiments. The first wireless device may be any of STA1-STA4 of FIG. 1, STA 200 of FIG. 2, or another suitable device which receives beamformed signals. The first wireless device may receive a beamformed data transmission from the second wireless device (701). The second wireless device may be, e.g., AP 110 of FIG. 1, AP 300 of FIG. 3, or another suitable BFER. The beamformed data transmission may be received through one or more of antennas 250(1)-250(n) and transceivers 211 of STA 200 of FIG. 2. The beamformed data transmission may be processed by frame formatting circuitry 222, by executing frame formatting and exchange software module 242, or by executing MMSE detector software module 243 of STA 200 of FIG. 2. The beamformed data transmission may be received by an MMSE detector (e.g., MMSE detector 213 of STA 200).

The first wireless device may use the received beamformed data transmission to determine an indication of channel throughput (702). The indication of channel throughput may be determined by the MMSE detector 213 and/or by executing MMSE detector software module 243 of STA 200 of FIG. 2. For some implementations, the indication of channel throughput may be based at least in part on an SINR value.

The first wireless device may then compare the indication of channel throughput to a threshold (703). The comparison may be performed by executing channel throughput comparison software module 245 of STA 200 of FIG. 2. For some implementations, this comparison may be performed by comparing the indication of channel throughput to a plurality of thresholds, where each of the plurality of thresholds is associated with a corresponding MIMO mode.

If the indication of channel throughput is below the threshold for the corresponding MIMO mode, then a notification of stale beamforming weights may be transmitted to the second wireless device (704). The notification may be generated by executing frame formatting and exchange software module 242 and/or using frame formatting circuitry 222 of STA 200 of FIG. 2. The notification may be transmitted using transceivers 211 and one or more of antennas 250(1)-250(n) of STA 200 of FIG. 2. As described above, the notification may indicate that the second wireless device (the BFER) may be using stale beamforming weights, and should consider sounding the channel to determine new beamforming weights. For some implementations, the notification may be provided within one or more bits (e.g., reserved bits) of a block acknowledgment (BA) frame transmitted from the first wireless device to the second wireless device.

FIG. 8 is an illustrative flow chart depicting an example operation 800 for the second wireless device (the BFER) dynamically determining whether to update beamforming characteristics based at least in part on a notification received from the first wireless device (the BFEE), in accordance with example embodiments. The second wireless device may be AP 110 of FIG. 1, AP 300 of FIG. 3, or another suitable BFER. First, a beamformed data transmission may be transmitted from the second wireless device to the first wireless device (801). The first wireless device may be any of STA1-STA4 of FIG. 1, STA 200 of FIG. 2, or another suitable BFEE. In accordance with example embodiments, the beamformed data transmission may use a MU-MIMO mode, such as a SU-BF mode, or an MU-n mode, where n is an integer that indicates the number of users at which MIMO transmissions are directed. The beamformed data transmission may be transmitted using one or more of antennas 360(1)-360(n) and transceivers 311 of AP 300 of FIG. 3. The beamformed data transmission may be generated by frame formatting circuitry 322, by executing frame formatting and exchange software module 342, and/or by executing beamforming software module 343 of AP 300 of FIG. 3.

Next, a notification of stale beamforming weights may be received from the first wireless device (802). In accordance with some embodiments, the notification of stale beamforming weights may be received as one or more reserved bits of a BA frame received from the first wireless device. The notification of stale beamforming weights may be received using one or more of antennas 360(1)-360(n) and transceivers 311 of AP 300 of FIG. 3. The notification of stale beamforming weights may be processed by frame formatting circuitry 322 and/or by executing frame formatting and exchange software module 342 of AP 300 of FIG. 3.

After receiving the indication of stale beamforming weights, a determination may be made that at least one beamforming attribute should be updated (803). This determination may be made by executing channel estimation software module 345 of AP 300 of FIG. 3. In accordance with example embodiments, this determination may be based at least in part on one or more of the notification of stale beamforming weights, a packet error rate (PER), a bit error rate (BER), or another suitable link quality parameter. For some implementations, this determination may include determining that new beamforming weights should be generated by performing a channel sounding procedure. For other implementations, this determination may include determining that better throughput may be obtained by switching to a different MIMO mode.

Next, at least one beamforming attribute for communicating with the first wireless device may be updated (804). This update may be performed by executing one or more of beamforming software module 343, channel sounding software module 344, or channel estimation software module 345 of AP 300 of FIG. 3. For some implementations, this update may include sounding the channel to determine new beamforming weights for communicating with the first wireless device (e.g., by executing channel sounding process 410 of FIG. 4 or performing another suitable channel sounding process). For other implementations, this update may include switching to a different MIMO mode. For example, this update may include switching to from a MU-MIMO mode to a SU-BF mode whose throughput may be less dependent on changes in the channel conditions.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method, performed by a first wireless device, for facilitating multiple-input multiple-output (MIMO) communications with a second wireless device, the method comprising:
receiving a beamformed data transmission from the second wireless device;
determining an indication of channel throughput based at least in part on the received beamformed data transmission;
comparing the indication of channel throughput to a threshold; and
transmitting a notification of stale beamforming weights to the second wireless device based at least in part on a determination that the indication of channel throughput is below the threshold.

2. The method of claim 1, wherein the indication of channel throughput is based at least in part on an estimation of a signal to interference plus noise ratio (SINR).

3. The method of claim 2, wherein the beamformed data transmission is received by a minimum mean squared error (MMSE) detector, and the MMSE detector estimates the SINR.

4. The method of claim 1, wherein the notification of stale beamforming weights indicates that the second wireless device is to update at least one beamforming attribute.

5. The method of claim 1, wherein the notification of stale beamforming weights indicates that the second wireless device is to calculate new beamforming weights based at least in part on a channel sounding operation.

6. The method of claim 1, wherein the notification of stale beamforming weights comprises one or more reserved bits in a block acknowledgement (BA) frame transmitted to the second wireless device.

7. The method of claim 1, wherein the comparing comprises:
comparing the indication of channel throughput to a plurality of thresholds, wherein each of the plurality of thresholds corresponds to a different MIMO mode.

8. A first wireless device for facilitating multiple-input multiple-output (MIMO) communications with a second wireless device, the first wireless device comprising:
one or more processors; and
a memory storing instructions that, when executed by the one or more processors, cause the first wireless device to:
determine an indication of channel throughput based at least in part on a received beamformed data transmission from the second wireless device;
compare the indication of channel throughput to a threshold; and
transmit a notification of stale beamforming weights to the second wireless device based at least in part on a determination that the indication of channel throughput is below the threshold.

9. The first wireless device of claim 8, wherein the indication of channel throughput is based at least in part on an estimation of a signal to interference plus noise ratio (SINR).

10. The first wireless device of claim 9, further comprising:
a minimum mean squared error (MMSE) detector to estimate the SINR based at least in part on the received beamformed data transmission.

11. The first wireless device of claim 8, wherein the notification of stale beamforming weights indicates that the second wireless device is to update at least one beamforming attribute.

12. The first wireless device of claim 8, wherein the notification of stale beamforming weights indicates that the second wireless device is to calculate new beamforming weights based at least in part on a channel sounding operation.

13. The first wireless device of claim 8, wherein the notification of stale beamforming weights comprises one or more reserved bits in a block acknowledgement (BA) frame transmitted to the second wireless device.

14. The first wireless device of claim 8, wherein execution of the instructions to compare causes the first wireless device to further
compare the indication of channel throughput to a plurality of thresholds, wherein each of the plurality of thresholds corresponds to a different MIMO mode.

15. A non-transitory computer-readable medium storing instructions that, when executed by one or more processors of a first wireless device, cause the first wireless device to facilitate multiple-input multiple-output (MIMO) communications with a second wireless device by performing operations comprising:
receiving a beamformed data transmission from the second wireless device;
determining an indication of channel throughput based at least in part on the received beamformed data transmission;
comparing the indication of channel throughput to a threshold; and
transmitting a notification of stale beamforming weights to the second wireless device based at least in part on a determination that the indication of channel throughput is below the threshold.

16. The non-transitory computer-readable medium of claim 15, wherein the indication of channel throughput is based at least in part on an estimation of a signal to interference plus noise ratio (SINR).

17. The non-transitory computer-readable medium of claim 16, wherein execution of the instructions causes the first wireless device to estimate the SINR using a minimum mean squared error (MMSE) detector.

18. The non-transitory computer-readable medium of claim 15, wherein the notification of stale beamforming weights indicates that the second wireless device is to update at least one beamforming attribute.

19. The non-transitory computer-readable medium of claim 15, wherein the notification of stale beamforming weights indicates that the second wireless device is to calculate new beamforming weights based at least in part on a channel sounding operation.

20. The non-transitory computer-readable medium of claim 15, wherein the notification of stale beamforming weights comprises one or more reserved bits in a block acknowledgement (BA) frame transmitted from the second wireless device.
